(19) United States
(12) Patent Application Publication
(10) Pub. No.: US 2007/0221252 A1
(43) Pub. Date: Sep. 27, 2007

(54) HIGH-PRESSURE PROCESSING METHOD

(76) Inventor: Hiromi Kiyose, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/562,680

(22) Filed: Nov. 22, 2006

(30) Foreign Application Priority Data
Nov. 22, 2005 (JP) 2005-337477

(51) Int. Cl. B08B 3/00

(52) U.S. Cl. 134/26

(57) ABSTRACT

An etching is performed to a wafer using a first processing fluid which is produced through the addition of a liquid mixture to a supercritical carbon dioxide, the liquid mixture including hydrogen fluoride, ammonium fluoride, and isopropyl alcohol, whereby SiO₂ film formed on the surface of the wafer is removed. Then, a rinsing is performed to the wafer using a second processing fluid which is produced through the addition of methanol to the supercritical carbon dioxide, or the addition of methanol and water to the supercritical carbon dioxide, whereby Si₂F₆ which results from the etching and remains to adhere to the surface of the wafer is removed.

### CROSS REFERENCE TO RELATED APPLICATION

The disclosure of Japanese Patent Application No. 2005-337477 filed Nov. 22, 2005 including specification, drawings and claims is incorporated herein by reference in its entirety.

### BACKGROUND OF THE INVENTION

1. Field of the Invention

The present invention relates to a high-pressure processing method in which an object-to-be-processed such as a substrate is cleaned under high pressure. A substrate includes a semiconductor wafer, a glass substrate for photomask, a glass substrate for liquid crystal display, a glass substrate for plasma display, a substrate for optical disk, etc.

2. Description of the Related Art

In the processing steps in which a series of processes are performed to a substrate such as a semiconductor wafer and the like as an object-to-be-processed, cleaning is an essential step to remove undesired substance such as a naturally-oxidized film and a chemically-oxidized film which are formed on the substrate itself or on a surface of various types of film formed on the substrate, and as a resist which has been coated on the substrate and is no longer required. Therefore, there have been already proposed, as one of the processing methods to remove these undesired substance from the substrate, processing methods to remove undesired substance from the substrate by making a high-pressure fluid such as supercritical fluid contact with a surface of the substrate (see JP-A-2002-237481 and JP-A-2004-158534).

### SUMMARY OF THE INVENTION

In the case where high-pressure fluid such as supercritical fluid is used, since the viscosity of the fluid is lower than the normal liquid, it becomes possible to clean inside fine patterns. And the material which is most commonly used as a high-pressure fluid which is transformed into supercritical state is carbon dioxide. Carbon dioxide is widely used, because it easily transforms into supercritical state. However, the polarity of supercritical carbon dioxide is about the same as nonpolar solvent such as hexane, hence, it is difficult to clean undesired substance from the substrate sufficiently.

Therefore, there is a suggestion that fluoride such as hydrogen fluoride, ammonium fluoride, or the like is mixed with supercritical carbon dioxide as a cleaning component, and the mixed fluid (processing fluid) is brought into contact with a substrate for processing in order to clean undesired substance from the substrate. However, in the case where fluoride is used as a cleaning component, there sometimes arises a following problem. That is, a large amount of by-product material remain on the substrate after the processing, hence, it becomes necessary to perform a cleaning step such as rinsing with water other than the process with high-pressure fluid in order to clean these by-product material.

The invention is made in light of the problem above. An object of the invention is to provide a high-pressure processing method and a high-pressure processing apparatus with which it is possible to clean an object-to-be-processed preferably under high pressure keeping by-product material from remaining.

According to an aspect of the present invention, there is provided a high-pressure processing method in which cleaning process is performed to an object-to-be-processed under high-pressure, the method comprising the steps of: a first processing for performing high-pressure processing to the object-to-be-processed using a first processing fluid which is produced through the addition of a liquid mixture to a high-pressure fluid, the liquid mixture including hydrogen fluoride, ammonium fluoride, and isopropyl alcohol; and a second processing for performing high-pressure processing to the object-to-be-processed, after the first processing step is performed, using a second processing fluid which is produced through the addition of methanol to the high-pressure fluid.

A high-pressure fluid used in the invention is preferably carbon dioxide, considering the safety and the price of carbon dioxide and the easiness of transforming carbon dioxide to a supercritical state. Other than carbon dioxide, a high-pressure fluid may be water, ammonia, dinitrogen monoxide, ethanol, etc. The reason of using a high-pressure fluid is that the dispersion coefficient of a high-pressure fluid is high and it is possible to disperse a dissolved contaminant in the medium. In the case where the high-pressure fluid is transformed to a supercritical fluid, the property of the fluid is between gas and liquid and the dispersion coefficient is nearer to gas, and it is possible to infiltrate into very fine patterns. In addition, a supercritical fluid, having a density which is close to that of a liquid, can contain a far greater amount of a composition for removal than a gas can.

A high-pressure fluid referred to in relation to the invention is a fluid whose pressure is equal to or higher than 1 MPa. Preferable high-pressure fluids are such fluids which are dense and highly soluble and exhibit low viscosities and high diffusive properties. More preferable high-pressure fluids are supercritical or subcritical fluids. Carbon dioxide may be heated up to 31 degrees Celsius and pressurized up to 7.4 MPa or beyond to be transformed into a supercritical fluid. Use of a subcritical fluid (high-pressure fluid) or supercritical fluid at 5 through 30 MPa is desirable particularly to a cleaning step, and it is more preferable to process at 7.4 through 20 MPa.

In the context of the invention, a “surface of an object-to-be-processed” means a surface which needs be subjected to high-pressure processing. When objects-to-be-processed are various types of substrates such as semiconductor wafers, glass substrates for photomasks, glass substrates for liquid crystal displays, glass substrates for plasma displays, substrates for optical disks, and the like, and in the case where it is necessary to perform high-pressure processing to one of the major surfaces of the substrate on which a circuit pattern and the like is formed, this major surface corresponds to “the surface of the object-to-be-processed” of the invention. Further, in the case where it is necessary to perform high-pressure processing to the other major surface, the other major surface corresponds to a “surface of an object-to-be-processed” of the invention. Of course, in the case where it is necessary to perform high-pressure processing to both of the major surfaces as in the case of a substrate whose both surfaces are mounting surfaces, both of the major surfaces correspond to a “surface of an object-to-be-processed” of the invention.

Further, in the context of the invention, cleaning process generally refers to any processing, including etching, of removing an undesired substance from an object-to-be-processed. Such cleaning process include removal of oxide film formed on a surface of an object-to-be-processed to start with, separation and removal of a resist from an object-to-be-processed such as a semiconductor substrate to which the resist has adhered, and the like. Objects-to-be-processed to which undesired substances have adhered include, but not limited to, semiconductor substrates, any objects in which discontinuous or continuous layers of different substances are formed or remain on substrates of various types of metal, plastic, ceramics, etc.

Further, in the context of the invention, silicon oxide includes various types of oxide film such as thermally-oxidized SiO₂ film, TEOS(tetraethylorthosilicate)-SiO₂ film, BPSG (Boronic-Phosphoric Silicate Glass) film, and the like.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a drawing which shows a high-pressure processing apparatus which is able to implement a high-pressure processing method according to the invention.

FIG. 2 is a flow chart which shows an embodiment of the high-pressure processing method according to the invention.

FIG. 3 is a drawing which shows conditions and results of examples.

### DETAILED DESCRIPTION OF THE PREFERRED EMBODIMENTS

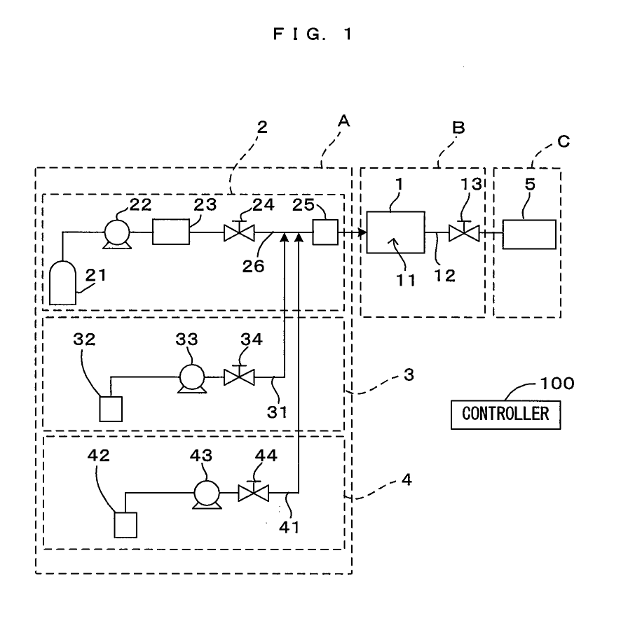

FIG. 1 is a drawing which shows a high-pressure processing apparatus which is able to implement a high-pressure processing method according to the invention. This high-pressure processing apparatus is an apparatus which executes an etching processing, a rinsing processing, and a drying processing to a substrate such as an approximately circular semiconductor wafer held in a processing chamber 11 which is formed inside a pressure container 1. The apparatus feeds a supercritical carbon dioxide, a mixture of supercritical carbon dioxide and an etching liquid, or a mixture of supercritical carbon dioxide and a rinsing liquid into the processing chamber 11 as a processing fluid to execute these processings. The etching liquid corresponds to “liquid mixture” of the invention. The structure and operations of this high-pressure processing apparatus will now be described in detail.

This high-pressure processing apparatus is equipped with three main units, which are (1) a processing fluid supply unit A which prepares the processing fluid and supplies the same to the processing chamber 11, (2) a cleaning unit B which comprises the pressure container 1, removes undesired substances such as SiO₂ film adhering to a substrate inside the processing chamber 11 of the pressure container 1 using the processing fluid, and (3) a reservoir unit C which collects and holds the high-pressure fluid used for cleaning.

Of these units, the processing fluid supply unit A comprises a high-pressure fluid supply section 2, an etching liquid supply section 3, and a rinsing liquid supply section 4. The high-pressure fluid supply section 2 pressure-feeds supercritical carbon dioxide (hereinafter called ‘SCF’) as the “high-pressure fluid” of the invention toward the pressure container 1. The etching liquid supply section 3 feeds an etching liquid which is appropriate to removal of undesired substances such as SiO₂ film. The rinsing liquid supply section 4 feeds a rinsing liquid which is appropriate to removal of by-product materials which remain on a substrate after etching processing.

The high-pressure fluid supply section 2 comprises a high-pressure fluid reservoir tank 21 and a high-pressure pump 22. In the event that supercritical carbon dioxide is used as a high-pressure fluid as described above, it is usually liquid carbon dioxide that is stored within the high-pressure fluid reservoir tank 21. Further, in the case where pressure loss including acceleration resistance is large, a fluid may be cooled in advance in a supercooling device (not shown) for prevention of gasification inside the high-pressure pump 22. As the high-pressure pump 22 pressurizes this fluid, high-pressure liquid carbon dioxide is obtained. The output side of the high-pressure pump 22 is connected with the pressure container 1 by a high-pressure pipe 26 in which a first heater 23, a high-pressure valve 24 and a second heater 25 are interposed. The high-pressure valve 24 opens in response to an opening and closing command received from a controller 100 which controls the entire apparatus, high-pressure liquid carbon dioxide pressurized by the high-pressure pump 22 is heated up by the first heater 23, whereby SCF is obtained as the high-pressure fluid, and then SCF is pressure-fed directly to the pressure container 1. In addition, the high-pressure pipe 26 branches out between the high-pressure valve 24 and the second heater 25, and a branch pipe 31 is connected with an etching liquid reservoir tank 32 of the etching liquid supply section 3, whereas a branch pipe 41 is connected with a rinsing liquid reservoir tank 42 of the rinsing liquid supply section 4.

When the etching liquid supply section 3 feeds an etching liquid into the high-pressure pipe 26 via the branch pipe 31, SCF and the etching liquid are mixed together, whereby the first processing fluid of the invention is prepared. On the other hand, when the rinsing liquid supply section 4 feeds a rinsing liquid into the high-pressure pipe 26 via the branch pipe 41, SCF and the rinsing liquid are mixed together, whereby the second processing fluid of the invention is prepared. In the case where the temperature of the fluid drops down below the critical temperature due to mixing of the etching liquid or the rinsing liquid in this manner, the second heater 25 heats up the processing fluid to transform the fluid back to supercritical state and supplies the same to the pressure container 1.

The etching liquid supply section 3 supplies an etching liquid for removal of SiO₂ film and the like as described above, and comprises the etching liquid reservoir tank 32 which stores an etching liquid. In this embodiment, a liquid mixture composed of hydrogen fluoride (HF), ammonium fluoride (NH₄F), and isopropyl alcohol (IPA) is used as the etching liquid, the mixture ratio of hydrogen fluoride being 0.001 to 1 mass %, ammonium fluoride being 0.001 to 1 mass %, and isopropyl alcohol being all the rest. At this stage, the effect of using such an etching liquid is now described.

In the processing fluid which is prepared by mixing hydrogen fluoride and ammonium fluoride to high-pressure fluid, there are [HF], [H⁺], [F⁻], [HF₂⁻], [NH₄⁺], and [NH₄HF₂] as main chemical species. Of these chemical species, the chemical specie which contributes most to removal of silicon oxide is only [HF₂⁻]. It is possible to control in some degree the abundance ratio of these chemical species in the equilibrium state by controlling dielectric constant of the system. Hence, isopropyl alcohol which is low-polarity and low dielectric constant is used as a solvent of the liquid mixture, whereby the abundance ratio of [HF₂⁻] is increased, and silicon oxide is removed efficiently. On the other hand, Si₂F₆ remains on the surface of the object-to-be-processed as a result of the etching process to the silicon oxide. However, the high-pressure processing with the second processing fluid containing methanol rinses and removes Si₂F₆ which remains on the surface of the object-to-be-processed efficiently.

Further, in order to clean the object-to-be-processed well while keeping the supercritical state, it is preferable to keep the concentration of the liquid mixture in the first processing fluid 1 to 10 mass %, while the mixture ratio of hydrogen fluoride in the liquid mixture keeping 0.001 to 1 mass %, the mixture ratio of ammonium fluoride in the liquid mixture keeping 0.001 to 1 mass %, and the rest of the liquid mixture being isopropyl alcohol.

It is more preferable to set the lower limit of the mixture ratio of hydrogen fluoride and ammonium fluoride to 0.01 mass %, respectively.

As described above, there exists in the liquid mixture [NH₄⁺] as a chemical specie other than [HF₂⁻] which contributes removal of oxide such as SiO₂ film. As a result, etching of material which constitutes substrate other than oxide is suppressed and etch selectivity to oxide is enhanced.

Hydrogen fluoride may be provided to SCF in the form of gas, or hydrofluoric acid which is solution of hydrogen fluoride in water may be provided to SCF. In the case where hydrofluoric acid is used, it is preferable to set the upper limit to 1 mass %, in order for water included in hydrofluoric acid not to prevent the processing fluid from transforming supercritical state.

The etching liquid reservoir tank 32 which stores such an etching liquid (liquid mixture) whose composition is as described above is connected with the high-pressure pipe 26 by the branch pipe 31. Further, a feed pump 33 and a high-pressure valve 34 are interposed in the branch pipe 31. Hence, as the high-pressure valve 34 opens and closes in response to an opening and closing command received from the controller 100, the etching liquid inside the etching liquid reservoir tank 32 is fed into the high-pressure pipe 26, whereby the first processing fluid (SCF and the etching liquid) is prepared. The first processing fluid is then supplied to the processing chamber 11 of the pressure container 1.

On the other hand, the rinsing liquid supply section 4 supplies a rinsing liquid for removal of by-product materials (remaining materials) other than the etching liquid, and comprises the rinsing liquid reservoir tank 42 which stores the rinsing liquid. The by-product materials result from etching processing of SiO₂ film and remain on a surface of the substrate. In this embodiment, methanol is used as the rinsing liquid. Methanol operates preferably in cleaning Si₂F₆ from the substrate, Si₂F₆ being a remaining product resulting from etching processing of silicon oxide.

It is preferable to keep the concentration of methanol in the second processing fluid 1 to 20 mass %, in order to remove by-product material well from the substrate while keeping the supercritical state.

Further, methanol with the addition of water may be used as the rinsing liquid. Water is contained in this manner, whereby removal of remaining product is accelerated. However, in the case where SCF is used as a high-pressure fluid, it is preferable to keep water not more than 30 mass % in relation to the total amount of methanol and water, in order to remove the remaining product well from the substrate while keeping supercritical state. Furthermore, it is preferable to keep the concentration of the contained material (methanol and water) in the second processing fluid 1 to 20 mass %.

The rinsing liquid reservoir tank 42 which stores the rinsing liquid described above is connected with the high-pressure pipe 26 by the branch pipe 41. Further, a feed pump 43 and a high-pressure valve 44 are interposed in the branch pipe 41. Hence, as the high-pressure valve 44 opens and closes in response to an opening and closing command received from the controller 100, the rinsing liquid inside the rinsing liquid reservoir tank 42 is fed into the high-pressure pipe 26, whereby the second processing fluid (SCF and the rinsing liquid) is prepared. The second processing fluid is then supplied to the processing chamber 11 of the pressure container 1.

In the cleaning unit B, the pressure container 1 is communicated with a reservoir section 5 of the reservoir unit C via a high-pressure pipe 12. Further, a pressure-regulating valve 13 is interposed in this high-pressure pipe 12. Hence, the processing fluid or the like inside the pressure container 1 is discharged to the reservoir section 5 as the pressure-regulating valve 13 opens, whereas as the pressure-regulating valve 13 closes, the processing fluid is locked inside the pressure container 1. Further, it is possible to adjust the pressure inside the processing chamber 11, by controlling opening and closing of the pressure-regulating valve 13.

The reservoir section 5 of the reservoir unit C may be a vapor-liquid separation container or the like. The vapor-liquid separation container separates SCF into a gas component and a liquid component which will be individually discarded through separate routes. Alternatively, the respective components may be collected (and if necessary purified) and reused. The gas component and the liquid component separated from each other by the vapor-liquid separation container may be discharged out of the system via separate paths.

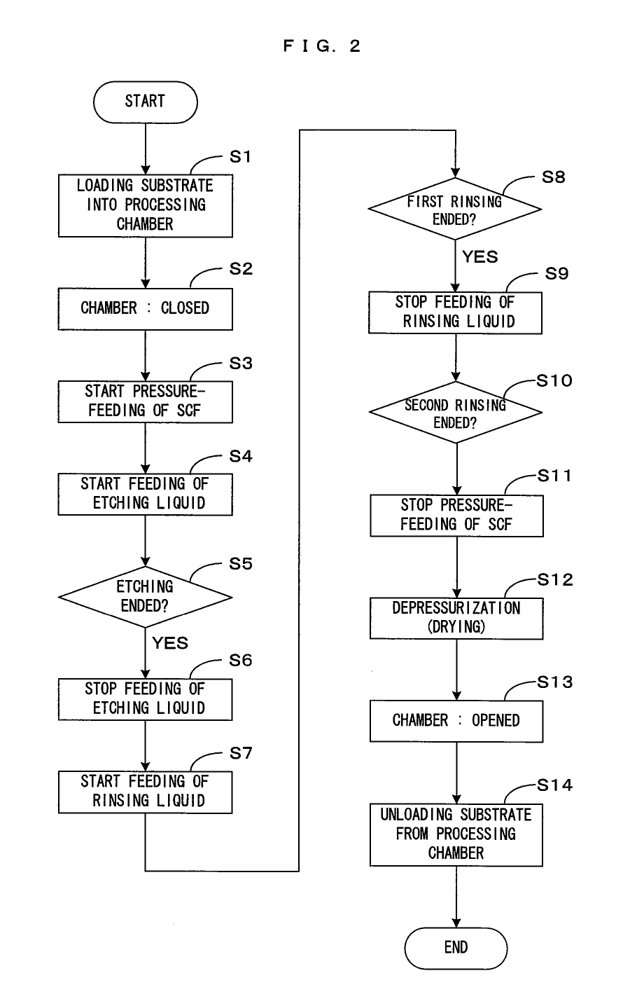

Next, the processing method by means of the high-pressure processing apparatus having the structure above will now be described referring to FIG. 2. FIG. 2 is a flow chart which shows an embodiment of a high-pressure processing method according to the invention. While this apparatus is in an initial state, the valves 13, 24, 34 and 44 are all closed and the pumps 22, 33 and 43 are in a halt.

When a handling apparatus such as an industrial robot and the like, or a transportation mechanism loads one substrate which is an object-to-be-processed at a time into the processing chamber 11 (Step S1), the processing chamber 11 is closed, which completes preparation for the processing (Step S2). Following this, after the high-pressure valve 24 opens, thereby making it possible to pressure-feed SCF into the processing chamber 11, the high-pressure pump 22 activates and pressure-feeding of SCF into the processing chamber 11 starts (Step S3). SCF is thus pressure-fed into the processing chamber 11, and the pressure inside the processing chamber 11 rises gradually. As the pressure-regulating valve 13 opens and closes under control in accordance with an opening and closing command from the controller 100 at this stage, the pressure inside the processing chamber 11 is kept constant, e.g., approximately at 20 MPa. This pressure adjustment by means of control of opening and closing of the pressure-regulating valve 13 continues until depressurization described later completes. In the case where adjustment of the temperature in the processing chamber 11 is necessary in addition, the processing chamber 11 may be set to a temperature suitable to surface processing using a heater (not shown) disposed in the vicinity of the pressure container 1.

The feed pump 33 then activates. As a result of this, the etching liquid (liquid mixture) for removal of SiO₂ film is fed into the high-pressure pipe 26 from the etching liquid reservoir tank 32 via the branch pipe 31, thereby blending the etching liquid with SCF and preparing the first processing fluid (Step S4). At this stage, opening and closing of the high-pressure valve 34 is controlled, whereby mixed quantity of the etching liquid is adjusted, hence, it becomes possible to control mixing of extremely small quantity of the etching liquid.

It is preferable to set the concentration of the etching liquid in the processing fluid 1 to 10 mass %, in order to etch and remove SiO₂ film well from the substrate under supercritical state. Further, it is more preferable to set the concentration of the etching liquid approximately 5 mass %. In the case where the concentration of the etching liquid is less than 1 mass %, the removal of SiO₂ film is impossible or requires more time. On the other hand, in the case where the concentration of the etching liquid is more than 10 mass %, it becomes difficult to keep the supercritical state due to the influence of the water component contained in the etching liquid.

The etching step starts by the start of the feed of the etching liquid as described above. The feed of SCF and the etching liquid (cleaning component) is performed continuously. In this manner, the first processing fluid (SCF and etching liquid) is supplied to the processing chamber 11, the cleaning component contacts the surface of the substrate, and undesired substance such as SiO₂ film and the like which is adherent to the substrate is removed (first processing step). Further, the processing fluid carrying the undesired substance is fed to the reservoir section 5 of the reservoir unit C via the high-pressure pipe 12. At this time, most of the product material which results from the etching process are removed from the surface of the substrate due to evaporation and the like. However, Si₂F₆ remains as by-product material on the surface of the substrate without being removed.

Upon completion of etching step (YES at Step S5), the high-pressure valve 34 is closed, and the feed pump 33 is stopped. This terminates supply of the etching liquid (Step S6). Subsequently, rinsing step is executed. The rinsing step is started by performing the first rinsing step with mixture of SCF and the rinsing liquid in order to remove the by-product material which remains on the substrate.

In the first rinsing step, the feed pump 43 is activated and the high-pressure valve 44 is opened, whereby rinsing liquid for removal of by-product material is fed into the high-pressure pipe 26 from the rinsing liquid reservoir tank 42 via the branch pipe 41. As a result, the second processing fluid is prepared by mixing the rinsing liquid with SCF (Step S7). It is preferable to set the concentration of the rinsing liquid in the processing fluid 1 to 20 mass %, in order to remove by-product material which remains on the surface of the substrate efficiently under supercritical state.

In this manner, the second processing fluid (SCF and rinsing liquid) is supplied to the processing chamber 11, the rinsing component contacts the surface of the substrate, by-product material which remains and adheres to the substrate is removed (second processing step). Upon completion of first rinsing step (YES at Step S8), the high-pressure valve 44 is closed, and the feed pump 43 is stopped. This terminates supply of the rinsing liquid (Step S9). However, SCF is kept fed under pressure and SCF alone is supplied into the processing chamber 11, thereby executing second rinsing step with SCF.

Upon completion of this rinsing step (YES at Step S10), the high-pressure pump 22 is stopped, which stops pressure-feeding of SCF (Step S11). The pressure inside the processing chamber 11 then returns back to the normal pressure, as the pressure-regulating valve 13 opens and closes under control (Step S12). SCF remaining inside the processing chamber 11 evaporates as gas during this depressurization, which makes it possible to dry the substrate without causing any inconvenience such as a stain on the substrate. Furthermore, in recent years, there are often formed fine patterns on the surface of the substrate, and the problem that the fine patterns are destroyed in drying process is highlighted. However, the above-mentioned problem is resolved by using the depressurization drying.

Once the processing chamber 11 has returned back to the normal pressure, the processing chamber 11 is opened (Step S13), and a handling apparatus such as an industrial robot and the like, or a transportation mechanism unloads thus cleaning processed substrate (Step S14). In this manner, a succession of surface processing, that is, etching (removal of oxide film), rinsing, and drying, is completed. The operation described above is repeated when a next unprocessed substrate is transported.

As described above, according to the processing method of this embodiment, fluid (first processing fluid) of SCF with the addition of liquid mixture is used, the liquid mixture, as the etching liquid, containing hydrogen fluoride, ammonium fluoride, and isopropyl alcohol. Hence, it is possible to remove the undesired substance such as SiO₂ film and the like which are adherent to the substrate efficiently. On the other hand, Si₂F₆ remains on the surface of the substrate as a by-product material resulting from the etching process. However, since the substrate after etching is processed using fluid (second processing fluid) of SCF with the addition of methanol alone or methanol and water as rinsing liquid, it is possible to remove the by-product material effectively. Therefore, the processings with the first processing fluid and second processing fluid are performed together, cleaning of the substrate is done well without remaining the by-product material.

The invention is not limited to the embodiments described above but may be modified in various manners besides the embodiment above, to the extent not deviating from the object of the invention. For instance, although the embodiment described above is directed to the application of the invention to a single wafer type processing apparatus which processes one substrate at a time, the invention is applicable also to a processing apparatus of the so-called batch type which processes multiple substrates simultaneously.

Further, as described above, silicon oxide of the invention includes various types of oxide film such as thermally-oxidized SiO₂ film, TEOS(tetraethylorthosilicate)-SiO₂ film, BPSG (Boronic-Phosphoric Silicate Glass) film, and the like. Therefore, the mixture ratio of hydrogen fluoride and ammonium fluoride in the first processing fluid may be changed, in order to have etch selectivity to these oxides different from each other.

### EXAMPLES

The examples according to the invention will be given. It is to be understood that the invention is not limited to the following examples, and that the variation may be made properly to the examples without departing from the scope suitable to the point described above and below, and those are included in the technical scope of the invention.

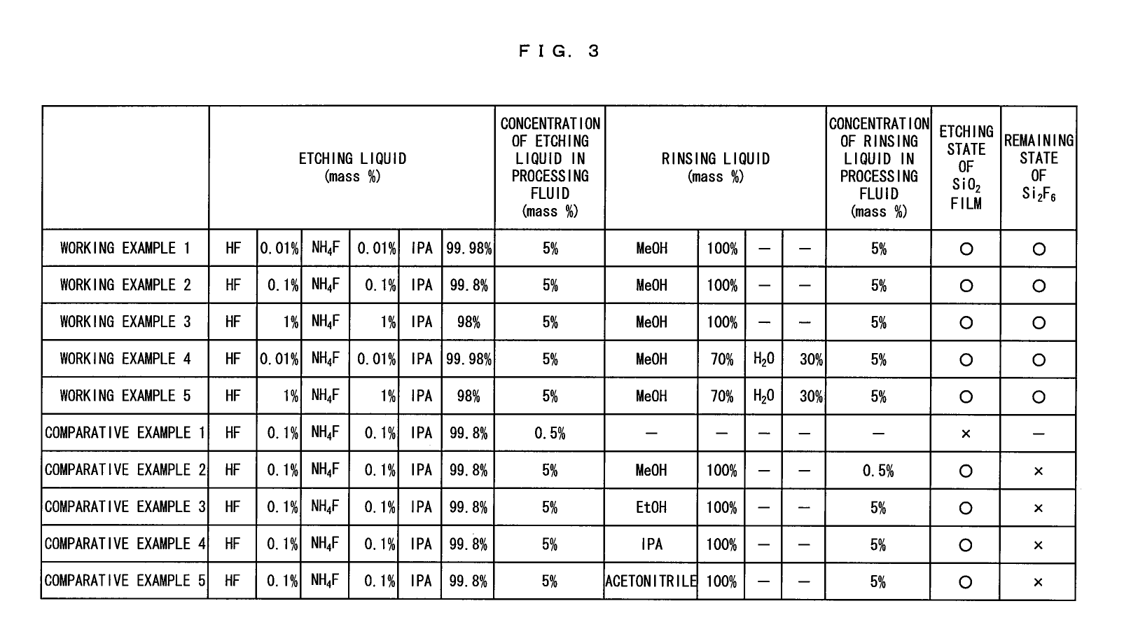

Working examples 1 through 5 according to the invention and comparative examples 1 through 5 for purposes of comparison only are described hereinafter with reference to FIG. 3. FIG. 3 is a drawing which shows conditions and results of working examples 1 through 5 and comparative examples 1 through 5.

A silicon wafer is prepared and SiO₂ film is formed on the silicon wafer. Then, a succession of processing (etching, rinsing, and drying) is performed to the silicon wafer on which SiO₂ film is formed as a substrate sample, using the apparatus described above. To be more specific, the substrate sample is loaded into the processing chamber 11, and the processing chamber 11 is closed. Then, while pressure-feeding SCF into the processing chamber 11, the pressure inside the processing chamber 11 is adjusted at 20 MPa by controlling opening and closing of the pressure-regulating valve 13. First, processing fluid (first processing fluid) of SCF with the addition of the liquid mixture the composition of which is shown in FIG. 3, as the etching liquid, is supplied to the processing chamber 11 to etch the substrate sample. Then, processing fluid (second processing fluid) of SCF with the addition of the rinsing liquid the composition of which is shown in FIG. 3, is supplied to the processing chamber 11 to rinse the substrate sample. Subsequently, rinsing is performed with SCF only, and lastly, the depressurizing drying is performed. Then, thus consecutive processing performed substrate sample is unloaded from the processing chamber 11. The surface of the substrate sample is examined under the scanning electron microscope, and the etching state of SiO₂ film and the remaining state of Si₂F₆ which is by-product material are checked.

It is to be noted that, in FIG. 3, the reference symbols “IPA”, “MeOH”, and “EtOH” indicate isopropyl alcohol, methanol, and ethanol, respectively. Further, the etching state of SiO₂ film and the remaining state of Si₂F₆ are evaluated as follows.

As to the etching state of SiO₂ film, mark “◯” indicates that there is no SiO₂ film remaining on the substrate, and mark “X” indicates that most of SiO₂ film remain on the substrate.

As to the remaining state of Si₂F₆, mark “◯” indicates that there is no Si₂F₆ recognized on the substrate, and mark “X” indicates that most of Si₂F₆ remain on the substrate.

In each of working examples 1 through 5, it is possible to etch and remove SiO₂ film from the wafer, to remove the by-product material Si₂F₆ well without remaining on the wafer, and to obtain excellent cleaning effect. On the other hand, according to the comparative example 1 in which the concentration of the etching liquid in the processing fluid is too low, SiO₂ film is not etched and removed sufficiently. Further, according to the comparative example 2 in which the concentration of the rinsing liquid in the processing fluid is too low, Si₂F₆ remains on the wafer. Furthermore, according to the comparative examples 3 through 5 in which ethanol, IPA, and acetonitrile, which are high-polar solvent like methanol or water, are respectively used instead of methanol, Si₂F₆ remains on the wafer and it is not possible to obtain enough removal effect.

The invention is applicable to a processing method and a processing apparatus which perform cleaning process to a substrate on which undesired substances such as oxide film and the like are adherent under high-pressure such as supercritical state. The oxide film includes various types of silicon oxide film such as thermally-oxidized SiO₂ film, TEOS(tetraethylorthosilicate)-SiO₂ film, BPSG (Boronic-Phosphoric Silicate Glass) film, and the like.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A high-pressure processing method in which cleaning process is performed to an object-to-be-processed under high-pressure, the method comprising the steps of:
a first processing for performing high-pressure processing to the object-to-be-processed using a first processing fluid which is produced through the addition of a liquid mixture to a high-pressure fluid, the liquid mixture including hydrogen fluoride, ammonium fluoride, and isopropyl alcohol; and
a second processing for performing, after the completion of the step of the first processing, high-pressure processing to the object-to-be-processed using a second processing fluid which is produced through the addition of methanol to the high-pressure fluid.

2. The high-pressure processing method of claim 1, in which a silicon oxide which adheres to a surface of the object-to-be-processed is removed, wherein
in the step of the first processing, the silicon oxide is removed from the surface of the object-to-be-processed by etching with the first processing fluid, and
in the step of the second processing, a by-product material is removed from the object-to-be-processed by rinsing with the second processing fluid, the by-product material resulting from the step of the first processing and remaining on the surface of the object-to-be-processed.

3. The high-pressure processing method of claim 1, wherein
a concentration of the liquid mixture in the first processing fluid is 1 to 10 mass %,
a mixture ratio of hydrogen fluoride in the liquid mixture is 0.001 to 1 mass %,
a mixture ratio of ammonium fluoride in the liquid mixture is 0.001 to 1 mass %, and
the rest of the liquid mixture is composed of isopropyl alcohol.

4. The high-pressure processing method of claim 1, wherein a concentration of methanol in the second processing fluid is 1 to 20 mass %.

5. The high-pressure processing method of claim 1, wherein the second processing fluid further includes water.

6. The high-pressure processing method of claim 5, wherein
a mixture ratio of water in relation to a total amount of methanol and water contained in the second processing fluid is not more than 30 mass %, and
a concentration of the total amount of methanol and water in the second processing fluid is 1 to 20 mass %.
